(19) United States
(12) Patent Application Publication
(10) Pub. No.: US 2026/0296834 A1
(43) Pub. Date: Oct. 1, 2026

(54) RAIL SEGMENT SYSTEM FOR MODULAR STAIRLIFTS

(71) Applicant: LeafFilter North, LLC, Hudson, OH (US)

(72) Inventors: Jason Crowell, Akron, OH (US); RuQing Liu, Cuyahoga Falls, OH (US); Tyler Vegh, Northfield, OH (US)

(73) Assignee: LeafFilter North, LLC, Hudson, OH (US)

(21) Appl. No.: 19/702,076

(22) Filed: Jun. 9, 2026

Related U.S. Application Data
(63) Continuation-in-part of application No. 18/620,227, filed on Mar. 28, 2024, now Pat. No. 12,673,848.
(60) Provisional application No. 63/492,921, filed on Mar. 29, 2023.

(51) Int. Cl. B66B 9/08

(52) U.S. Cl. CPC B66B 9/0846

(57) ABSTRACT

A rail segment for a stairlift including a body, a first keying protrusion, and a first keying recess that is in alignment with, and has a complementary shape to, the first keying protrusion. The first keying recess is configured to lockingly engage with a second keying protrusion extending from an adjacent modular rail segment. An axis of rotation is defined adjacent a distal end of the first keying recess and parallel to each of the first face and second face. The first keying recess is configured to permit the second keying protrusion of the adjacent modular rail segment to be lockingly engaged therein via pivotably rotating the adjacent modular rail segment toward the rail segment about the axis of rotation, so as to pivotably rotate the second keying protrusion into engagement with the first keying recess to couple the adjacent modular rail segment to the rail segment.

### CROSS-REFERENCE TO RELATED APPLICATIONS

This application is a continuation-in-part of U.S. patent application Ser. No. 18/620,227, titled “Stair Lift Systems and Method for Assembling, Installing, and Using Such Systems,” filed Mar. 28, 2024, which claims the benefit of U.S. Provisional Patent Application Ser. No. 63/492,921, titled “Stair Lift Systems and Methods for Assembling, Installing, and Using such Systems,” filed Mar. 29, 2023. The disclosures of each prior application are hereby incorporated by reference in their entireties.

### FIELD OF INVENTION

The present disclosure generally relates to stair lift systems comprising configurable subcomponents and methods for assembling such subcomponents into a stair lift system, installing such stair lift systems, and using such stair lift systems. More specifically, the present disclosure relates to stair lift systems comprising a modular rail assembly having a number of customizable subcomponents arranged to be assembled in a variety of configurations to accommodate varying requirements of disparate pre-existing curved stairways and staircases without the need for the manufacture of customized components or systems.

### BACKGROUND

In recent years, the requirements and demands of the residential home remodeling and home improvement markets have evolved to include a broader demographic and an ever-growing variety of services. Traditionally, most consumers justify the cost of remodeling a home because remodeling increases the value of the home, repairs defects to the home, improves energy efficiency, and/or updates the aesthetic styling and amenities of the home. However, with the increased aging of the world's population, particularly in industrialized countries, more and more consumers are remodeling homes to satisfy aging consumers'desires to safely remain in their homes longer despite physical limitations that come with aging. The same can be said for younger consumers that either through injury or disease have physical limitations. The general trend is that consumers want to remain independent and in their familiar home environment as long as possible. In addition to the understandable desire to continue to live independently, the cost of in-home care, assisted living facilities, and other such alternatives often provide an economic incentive for aging consumers to remodel their residential homes to safely accommodate consumers with physical limitations.

As noted, today's older consumers are more independent and commonly choose to remain in their residential home much longer than prior generations. In one estimate, the number of Americans over the age of 65 will increase from 54 million in 2020 to 80 million in 2040, which includes a more than doubling of Americans over the age of 85 from 7 million to 15 million. This growth in the number of aging Americans has a proportional effect on the number of homeowners over the age of 65. In the last decade, the number of homeowners over the age of 65 has increased by 9 million, and it is expected that this number will grow by an additional 19.3 million persons in the next decade. As the population ages, many more home remodeling projects will focus on making the home safer for aging, particularly those with mobility limitations, that desire to remain in their homes. Even today, 45% of consumers cite making a home safer and more useable for an aging resident as one of the reasons for remodeling a home. This percentage is sure to grow in the coming years.

While there are often many projects required to make a home safe and efficient for an aging resident, transforming a two or more-story home into a space that is accessible for those with mobility issues may be of utmost importance. For any aging person to remain in his or her residential home, rather than moving to a single-story dwelling or foregoing the additional living space above or below the ground floor, it is important to facilitate movement between a first and second floor of the home or the first floor and basement of the home. One method of accommodating this need is to install a stair lift system that allows a user to sit in a chair and be transported up a staircase using a complicated stair rail system. In most cases, the stair rail system is custom-built for each homeowner's unique staircase. Often custom-built stair rail systems are required because of the wide variety and variations of staircases that can be found in homes. These variations are driven by many factors such as the age of a home, architecture style of a home, and local or regional home builder preferences, practices, and regulations. This often results in long lead times and delays between a consumer contacting a stair lift provider and the successful installation in the stair lift in the consumer's home. Between the first contact and the successful installation, the stair lift provider must visit the home, take a number of measurements, provide an estimate and quote to the consumer, the manufacturer must custom make the stair lift system, and the stair lift provider must install the stair lift system in the customer's home. And if any component of the customized system is not manufactured specifically to the custom specifications or there is an error in the initial measurements, there may need to be reworking or remanufacturing of such components. Such a process may last several weeks or even several months, which results in the consumer remaining confined to one floor of the home or remaining confined to an assisted living facility until that multi-step process is completed.

The long process of custom designing and building a traditional stair lift system can last several weeks or even several months, which becomes an even more apparent problem when a consumer's quality of life is degraded because of the inability to access the full extent of their home. Further, in certain situations, a consumer is unable to be released from a hospital, nursing home, or other caregiving facility without having the proper stair lift system in their home so that they can safety navigate their independent living situation. Often, a consumer does not realize they need a stair lift system until an occurrence of a debilitating event, such as a fall for example. Once such a debilitating event occurs the consumer needs an adequate stair lift system nearly immediately. The consumer does not have several weeks or several months to wait for a custom stair lift system to be built and installed. In essence, the consumer is at the mercy of the current slow and error prone ordering and installation processes.

Therefore, it is desirable to develop a more efficient approach to the design, fabrication, delivery, and installation of stair lift systems that offers flexibility and variability in configuration and arrangement so as to require a short period of time between the placement of a consumer order for a stair lift system and the installation of that system in a consumer's home. Such an efficient approach is needed to meet the market's demands for installing stair lift systems in a wide variety of stairways and staircases configurations at a reasonable cost without unnecessarily extending the overall project schedule.

### SUMMARY

In some embodiments, a rail segment for a stairlift includes a body having a first face and a second face opposite the first face. The first and second faces are disposed at a non-parallel angle to each other. The rail segment includes a first keying protrusion disposed on and extending from the first face. The rail segment includes a first keying recess defined in the second face that is in alignment with, and has a complementary shape to, the first keying protrusion. The first keying recess is configured to lockingly engage with a second keying protrusion extending from an adjacent modular rail segment, which second keying protrusion has an identical shape to that of the first keying protrusion. The rail segment includes an axis of rotation defined adjacent a distal end of the first keying recess and parallel to each of the first face and second face. The first keying recess is configured to permit the second keying protrusion of the adjacent modular rail segment to be lockingly engaged therein via pivotably rotating the adjacent modular rail segment toward the rail segment about the axis of rotation, so as to pivotably rotate the second keying protrusion into engagement with the first keying recess to couple the adjacent modular rail segment to the rail segment.

In some embodiments, a rail system for a stairlift includes a first rail segment having a central longitudinal axis and a second rail segment. The first rail segment and the second rail segment are coupled to one another in series in a direction of the central longitudinal axis via a pivoting rotational coupling motion in one rotational degree of freedom about an axis of rotation that is perpendicular to the central longitudinal axis, such that the first rail segment and the second rail segment are coupled together to form a curved section of rail.

### BRIEF DESCRIPTION OF THE DRAWINGS

In the accompanying drawings, structures are illustrated that, together with the detailed description provided below, describe example embodiments of the disclosed apparatus and methods. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 is a schematic representation of a modular rail assembly for use with a stair lift system.

FIG. 2 is a schematic illustration of a prior art stair lift system.

FIG. 3 is a perspective view of a variety of components useful in assembling an embodiment of a modular rail assembly for use with a stair lift system.

FIG. 4 schematically illustrates a perspective view of another corner rail segment for use with a modular rail assembly.

FIGS. 5-6 schematically illustrate perspective views of discs for use in corner rail segments.

FIGS. 7-8 schematically illustrate side views of discs for use in corner rail segments.

FIGS. 9-10 schematically illustrate top and bottom views of discs for use in corner rail segments.

FIG. 11 schematically illustrates a side view of two discs coupled together for use in corner rail segments.

FIGS. 12-13 schematically illustrate perspective views of a first connector component for use in corner rail segments.

FIG. 14 schematically illustrates a perspective view of the first connector component and a disc coupled together for use in corner rail segments.

FIGS. 15-16 schematically illustrate perspective views of a second connector component for use in corner rail segments.

FIG. 17 schematically illustrates a perspective view of the second connector component and a disc coupled together for use in corner rail segments.

FIG. 18 schematically illustrates a side view of an assembled corner rail segment with a cable.

FIG. 19 schematically illustrates a perspective view of a partially assembled corner rail segment with a cable.

FIG. 20 schematically illustrates a front perspective view of another embodiment of a disc for use in corner rail segments.

FIG. 21 schematically illustrates a rear perspective view of the disc of FIG. 20.

FIG. 22 schematically illustrates a front plan view of the disc of FIG. 20.

FIG. 23 schematically illustrates a front perspective view of another embodiment for a first coupling component for use in corner rail segments.

FIG. 24 schematically illustrates a rear perspective view of the first coupling component of FIG. 23.

FIG. 25 schematically illustrates a front perspective view of another embodiment for a second coupling component for use in corner rail segments.

FIG. 26 schematically illustrates a rear perspective view of the second coupling component of FIG. 25.

FIG. 27 illustrates a side view of rail segments engaging, according to an embodiment.

FIG. 28 illustrates a side view of a rail portion formed of multiple rail segments, according to an embodiment.

FIGS. 29-35 illustrate various views of a rail segment, according to an embodiment.

FIGS. 36-38 illustrate various views of a male rail segment, according to an embodiment.

FIGS. 39-41 illustrate various views of a female rail segment, according to an embodiment.

FIGS. 42-44 illustrate a number of arrangements for rails for use with stair lift systems.

### DETAILED DESCRIPTION

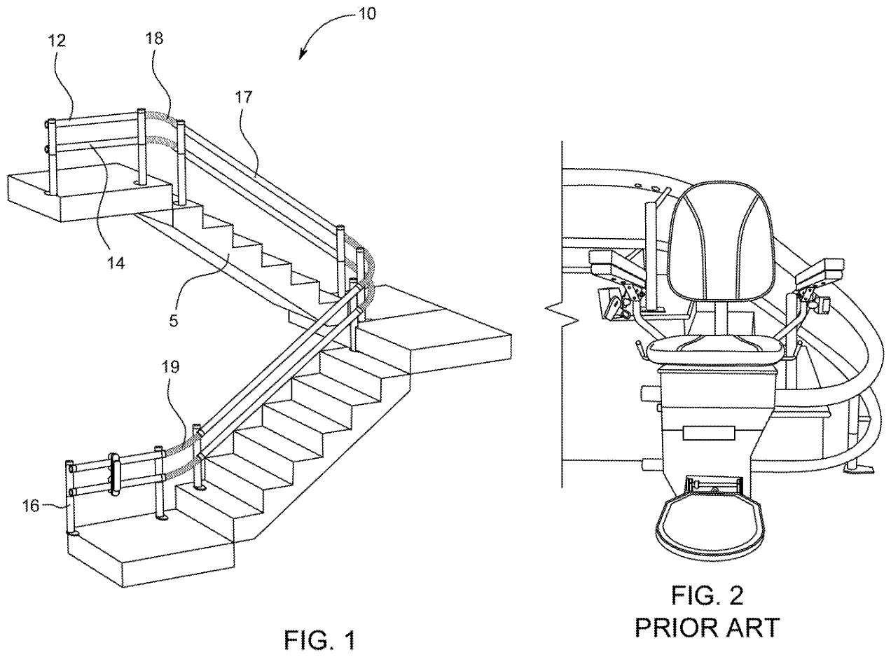

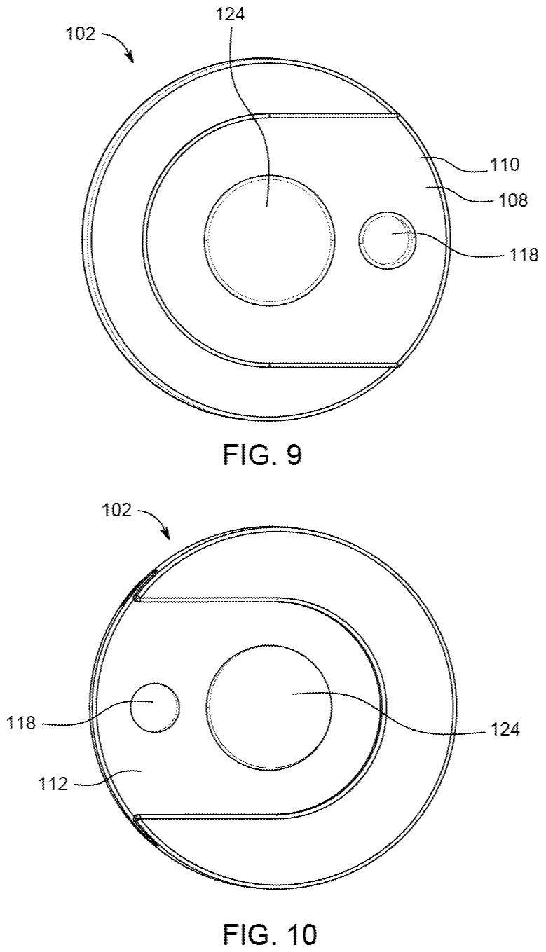

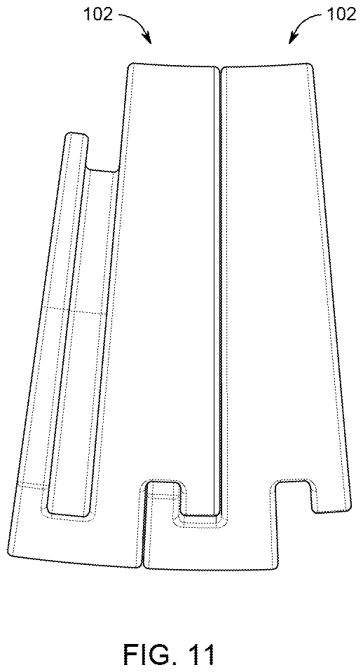

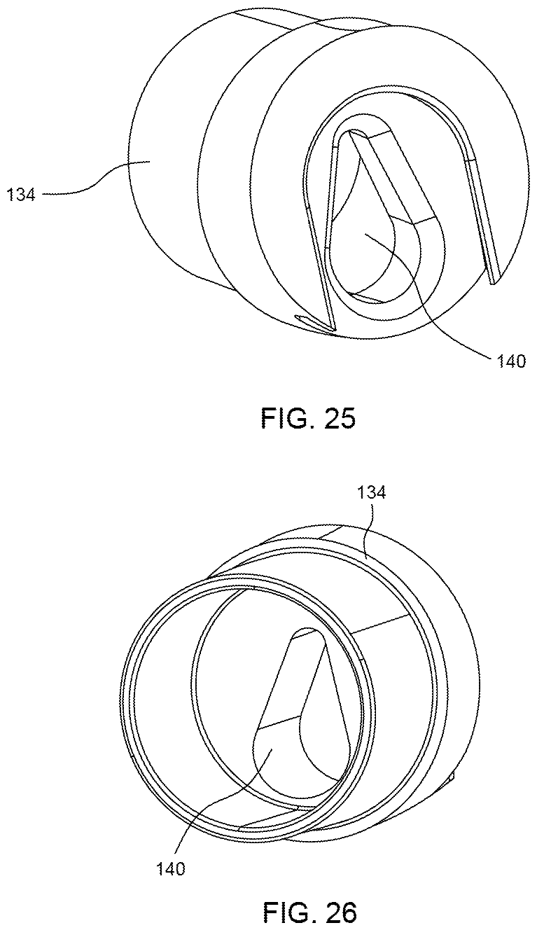

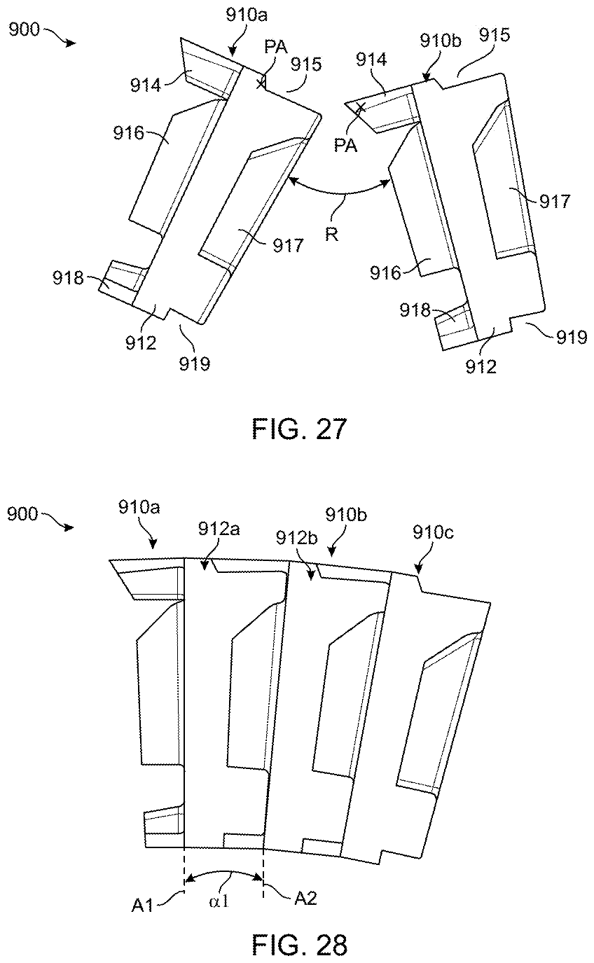

The apparatus, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, methods, etc. are either related to a specific example presented or are merely a general description of such a technique, arrangement, method, etc. Identifications of specific details or examples are not intended to be and should not be construed as mandatory or limiting unless specifically designated as such. Selected examples of stair lift systems that include a modular rail assembly and a chair that can be configured and assembled to accommodate a large variety of stairways and staircases are hereinafter disclosed and described in detail with reference made to FIGS. 1-44 .

As will be described in detail herein, this disclosure is directed to embodiments of stair lift systems with modular stair rail assemblies and a variety of subsystems for convenient operation and safety that together are suitable for forming a stable and configurable system to assist a user in traversing pre-existing stairways and staircases in residential and commercial settings. The embodiments are arranged to facilitate efficient manufacturing, transporting, inventorying, sourcing, distributing, delivering, assembling, and installing such stair lift systems regardless of the arrangement or configuration of the pre-existing stairway or staircase. In particular, the modular stair rail assemblies disclosed herein (also referred to generally as “rail systems”) can include multiple subcomponents that are arranged to be interchangeably assembled to accommodate the spatial, dimensional, and physical arrangement and configuration of the large variety of pre-existing residential and commercial stairways and staircases. Such stair lift systems, and specifically, such modular rail assemblies and modular post assemblies, can be customized and assembled on-site during the installation process by a contractor, other such worker, or even a homeowner. Once the modular post assemblies are assembled, several can be secured to one side of the treads of the staircase from the bottom of the staircase to the top of the staircase. Then the modular rail assembly can be configured and assembled (as a pair of rail subassemblies) and secured to the modular post assemblies along one side of the staircase such that the modular rail assembly extends from the bottom of the staircase to the top of the staircase. A chair can be engaged with the rail assembly such that the chair can traverse the length of the rail assembly to move the chair and its occupant selectively and safely between the bottom and the top of the staircase. In certain embodiments, the rail system can be secured directly to the treads of a staircase without the need for posts. Embodiments of stair lift system described herein are suitable for staircases that include landings and turns along the staircase as well as straight staircases.

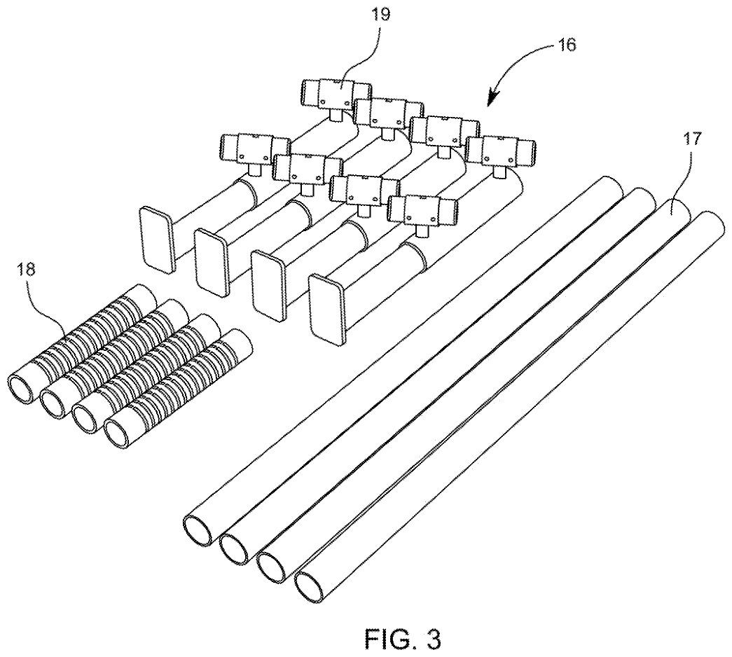

FIG. 1 schematically illustrates one embodiment of a modular rail assembly 10 installed and secured at one edge of a pre-existing staircase 5. The modular rail assembly 10 includes an upper rail subassembly 12 and a lower rail subassembly 14 supported by a series of modular post assemblies 16. It will be appreciated that the modular rail assembly 10 is customized to accommodate the angle of the staircase, the size of the lower, middle, and upper landings, and the 180 degree turn at the middle landing. FIG. 2 illustrates a prior art stair lift system. The stair lift system uses a dual rail arrangement equipped with a traction drive system, propelling the chair from a first lower floor in a home to a second, higher floor in the home. It will be appreciated that prior art lift chairs and drive systems, including traction drive systems, may be combined with the modular rail assemblies disclosed herein. Moreover, the modular rail assemblies may be adapted to accommodate various embodiments of commercially available lift chairs or lift chairs built specifically for use with the modular rail assembly.

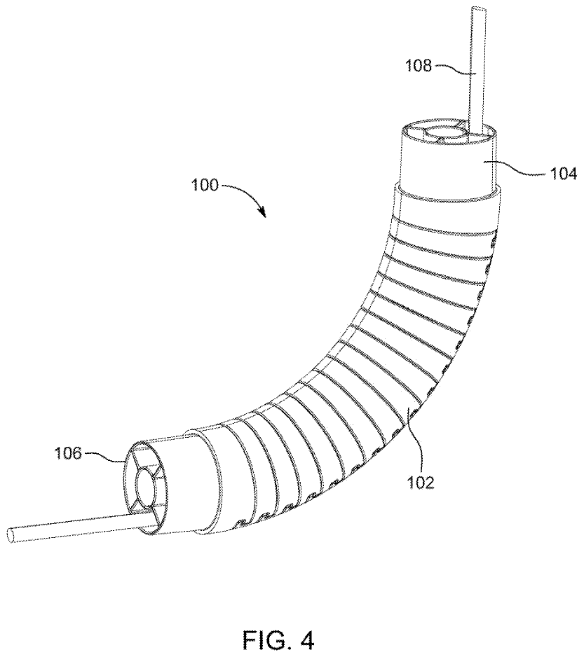

As shown in FIG. 1 and FIG. 3, the modular rail assembly (also referred to herein as a “rail assembly”) 10 may include a plurality of modular post assemblies 16, a plurality of straight rail segments or segments 17, and a plurality of corner rail segments or segments 18. The modular post assemblies 16 and rail segments 17 and 18 may be joined together to form the rail assembly 10 using connectors 19 coupled to the modular post assemblies 16. The corner rail segments 18 illustrated in FIG. 3 are designed to bend to accommodate the configuration of the customer's staircase, allowing an installer to dynamically customize the shape and arrangement of the rail assembly during the installation process.

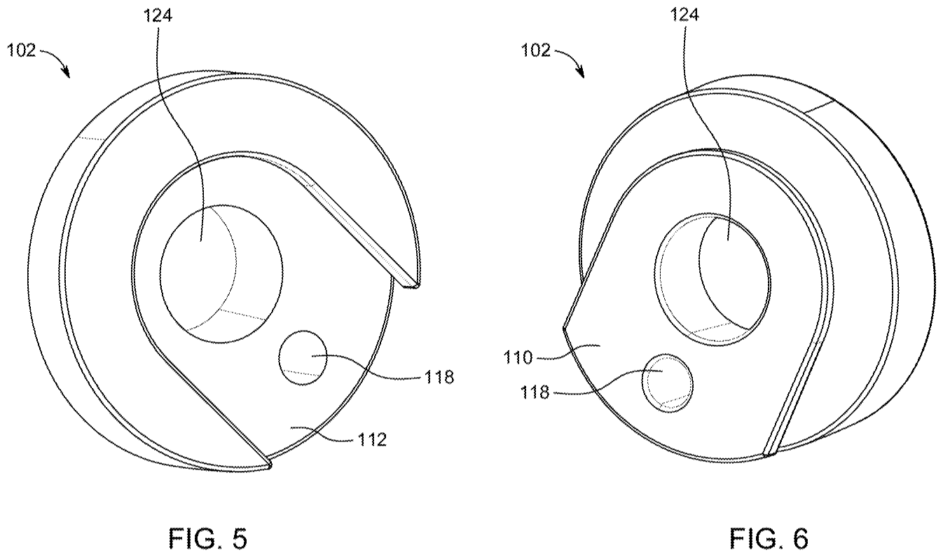

Referring generally to FIGS. 4-44, various embodiments of modular rail components (e.g., rail segments, corner rail segments) are shown and described. Specifically, the embodiments shown and described are components that allow for customizable bends (e.g., corners, etc.) within a rail. In some embodiments, the modular rail components can include individual pieces that can be arranged to form a desired bend or curved rail segment or corner rail segment. In some embodiments, a turning radius, bend radius, or radius of curvature of the curved rail segment (also called a corner rail segment) associated with the pieces can be based on a desired turning radius for a carriage moving along the rail.

As noted herein, several different embodiments of corner rail segments can be used with modular rail assemblies. In another embodiment, the corner rail segments themselves are an assembly of components and are highly configurable. FIGS. 4-19 illustrate a modular corner rail assembly 100 for use with modular rail assemblies and stair lift systems disclosed herein. The modular corner rail assembly 100 includes a plurality of inter-engaging discs 102, a first coupling component 104, a second coupling component 106, and a cable 108. Depending on the particular requirement of a pre-existing staircase, an appropriate number of discs 102 are selected and positioned adjacent to one another. The discs 102 are designed to engage with and be secured to adjacent discs 102. The discs 102 are designed so that one surface of the disc 102 is at an angle to the opposite surface of the disc 102. In one embodiment, the angle between the surfaces is approximately five degrees. In such an arrangement, if the modular corner rail assembly 100 needed a ninety degree bend, fifteen discs 102 together with the coupling components 104 and 106 can be used. The ninety degree bend is facilitated by fifteen discs 102 each at five degrees (totaling 75 degrees) and the first coupling component 104 including a seven degree angled surface and the second component 106 including an eight degree angled (adding another 15 degrees to total 90 degrees). It will be appreciated that the design of the discs 102 provides an installer with a wide variety of possibilities for arranging the modular corner rail assembly 100.

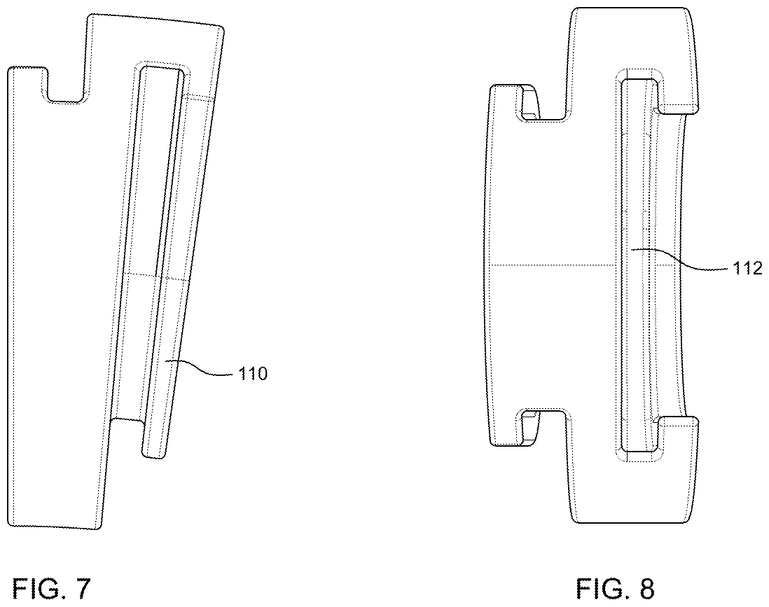

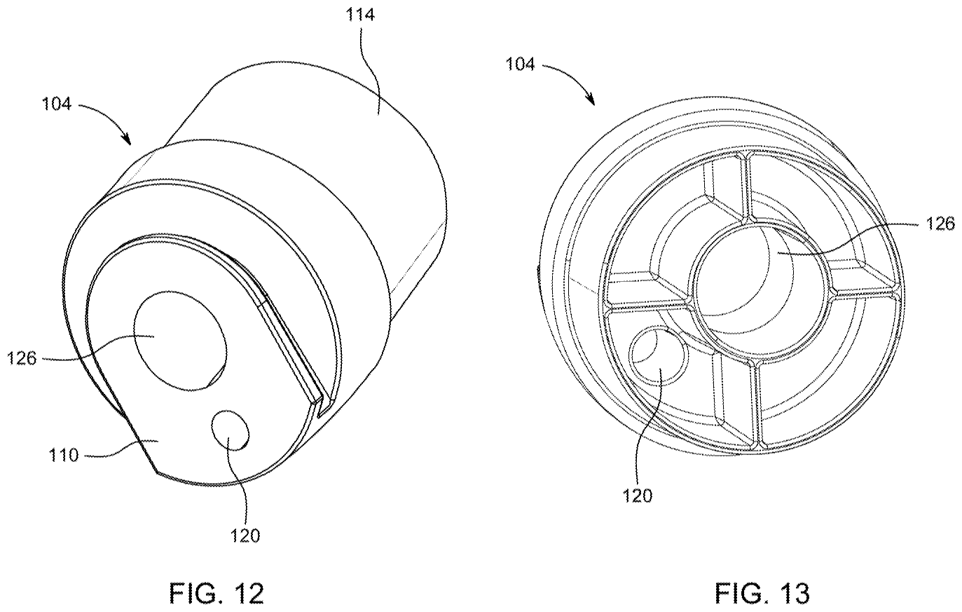

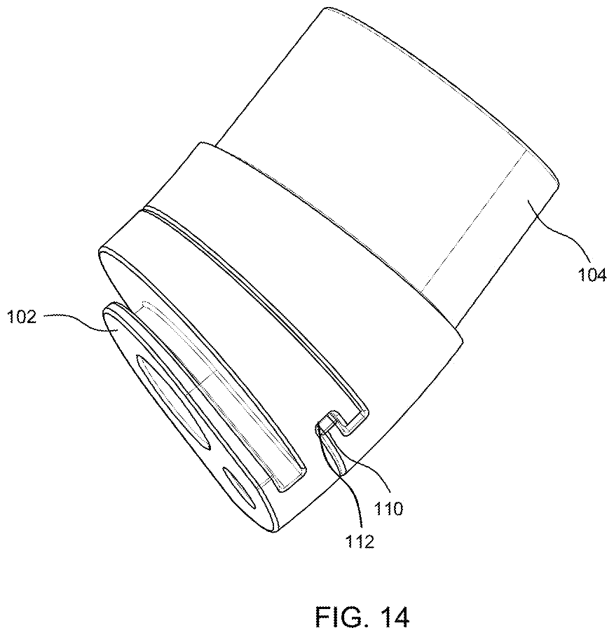

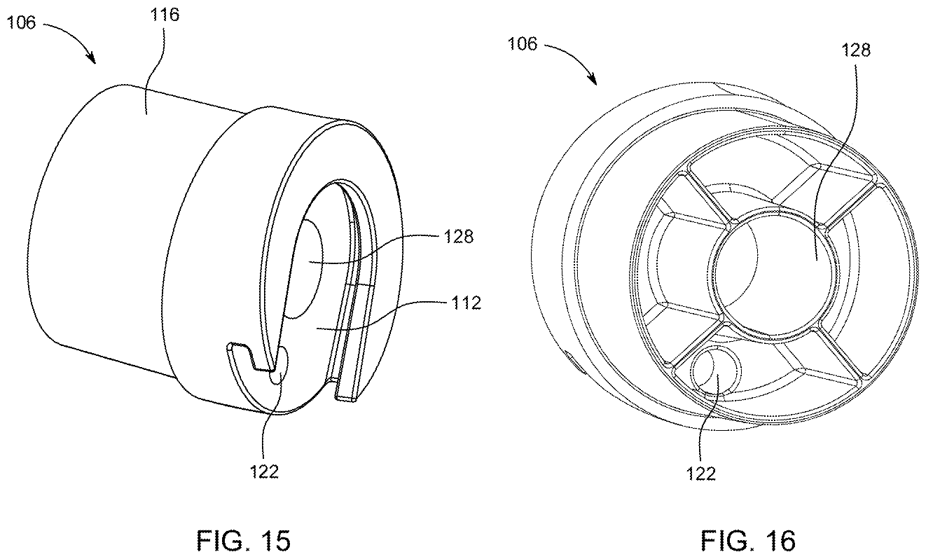

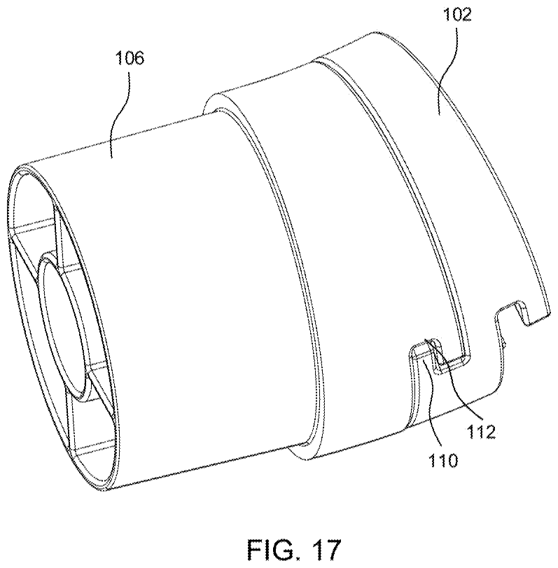

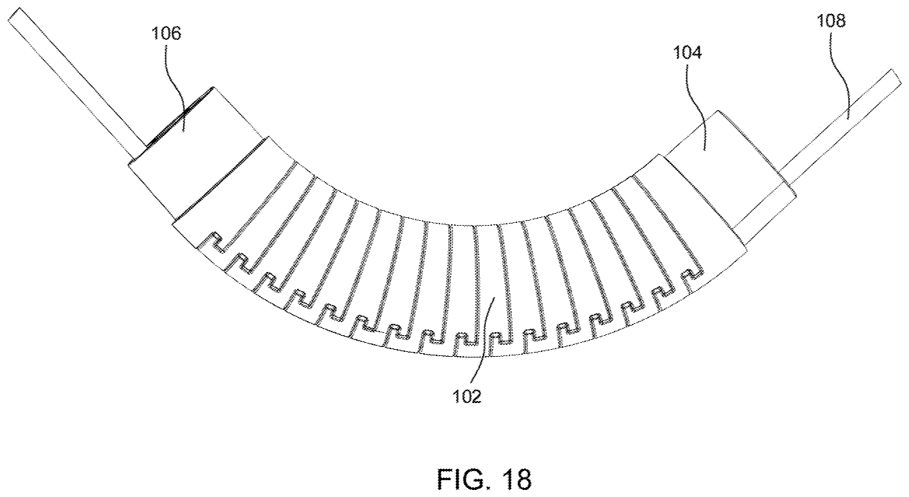

Each disc 102 includes matching interlocking features that facilitate engagement with adjacent discs 102. As illustrated in FIGS. 5-11, one side of the disc 102 includes a protrusion 110, and the opposite side of the disc 102 includes a slot 112 arranged to accommodate the protrusion 110. FIG. 11 illustrates a side view of two discs 102 engaged. When so engaged, the arrangement of the protrusion 110 and slot 112 restrain movement between the two discs 102 to form a stable assembly. As noted above, the number of discs 102 selected is based on the particular requirement, and more specifically, the angle or degree of curvature that the modular rail assembly needs to accommodate. Disposed at the opposing ends of the plurality of coupled together discs 102 are each of a first coupling component 104 and a second coupling component 106. As illustrated in FIGS. 12-14, one end of the first coupling component 104 includes a protrusion 110 matching the protrusion on the disc 102. The opposite end of the first coupling component 104 includes a collar 114 that can be used to couple the modular corner rail assembly 100 to other modular rail assembly components, such as a connector on a modular post assembly or a straight rail segment. FIG. 14 illustrates the first coupling component 104 engaged with a disc 102, where the protrusion 110 of the first coupling component 104 is positioned within the slot 112 of the disc 102. As illustrated in FIGS. 15-17, one end of the second coupling component 106 includes a slot 112 that is complementary to and matches a portion of the shape of the protrusion 110 on the disc 102, such that the slot 112 can accommodate the insertion of the protrusion 110 therein. The opposite end of the second coupling component 106 includes a collar 116 that can be used to couple the modular corner rail assembly 100 to other modular rail assembly components. FIG. 17 illustrates the second coupling component 106 engaged with a disc 102, where the protrusion 110 of the disc 102 is positioned within the slot 112 of the second coupling component 106.

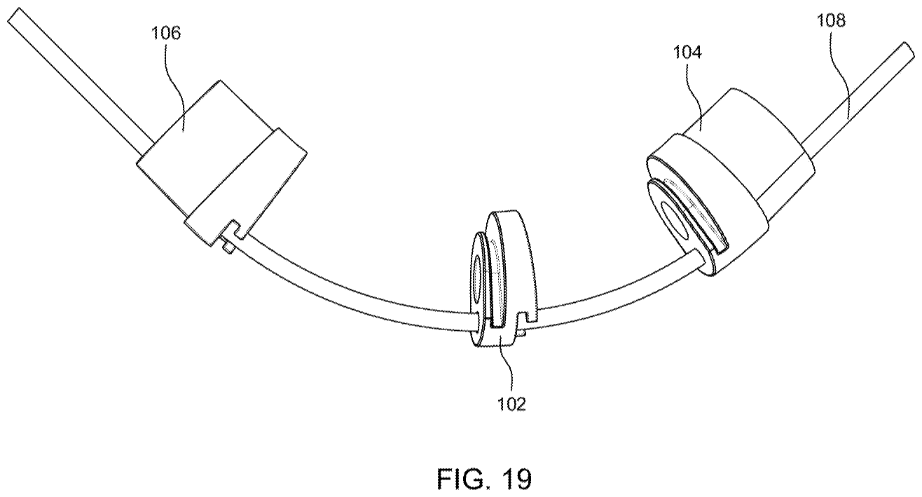

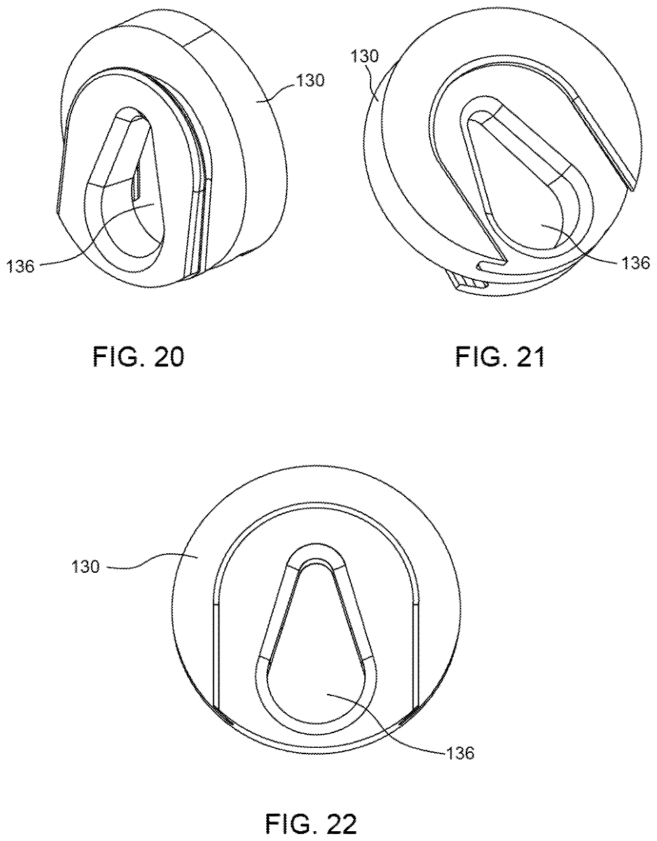

To add additional stability to the modular corner rail assembly 100, a cable 108 can be added to the modular corner rail assembly 100. Each of the components in the modular corner rail assembly 100 includes an aperture (for disc 102, aperture 118; for first coupling component 104, aperture 120; and for second coupling component 106, aperture 122). When the modular corner rail assembly 100 is assembled, all the apertures (118, 120, 122) align and the cable 108 is passed through the apertures (118, 120, 122, as illustrated in FIG. 4). FIG. 18 illustrates a side view of a modular corner rail assembly 100 fully assembled with a cable 108 (i.e. tensioning cable), and FIG. 19 illustrates a partially assembled modular corner rail assembly 100 that shows the positioning of the cable 108 through the apertures (118, 120, 122). In addition to passing the cable 108 through the components of the modular corner rail assembly 100, the cable 108 can be passed through all components of a modular rail assembly and tightened to secure the various components and further stabilize the modular rail assembly. The inter-engaging discs 102, first coupling component 104, and second coupling component 106 can each further include a central aperture (124, 126, 128, respectively). As with the prior described apertures (118, 120, 122) that accommodate the cable 108, the central apertures (124, 126, 128) are aligned when the discs 102, first coupling component 104, and second coupling component 106 are assembled into a modular corner rail assembly 100. Certain components of the stair lift system can be positioned through these central apertures (124, 126, 128) such as a power cord or cable that supplies electrical power. Such a power cord can run along a section of the rail system or the entire length of the rail system and supply power to different components of the stair lift system.

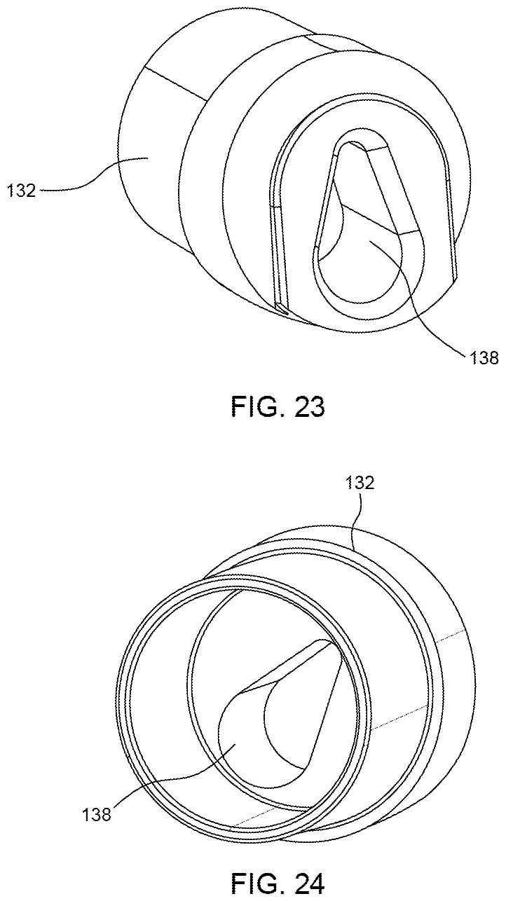

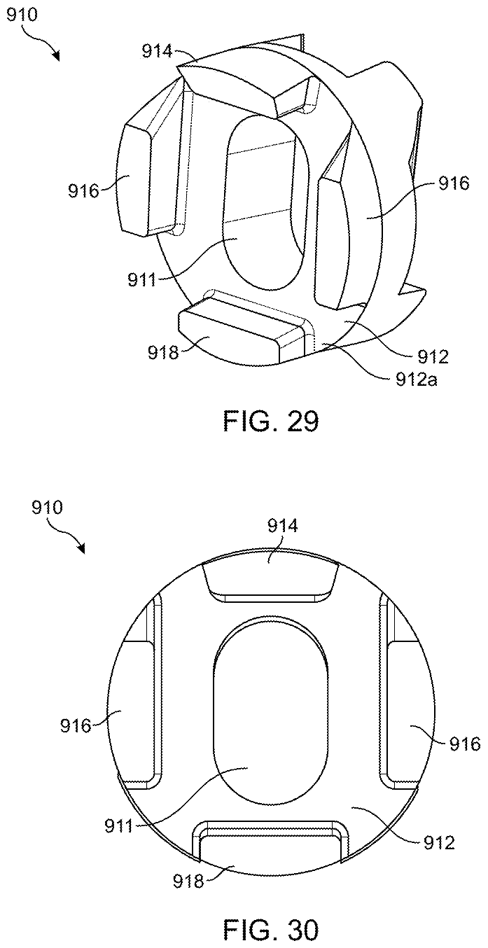

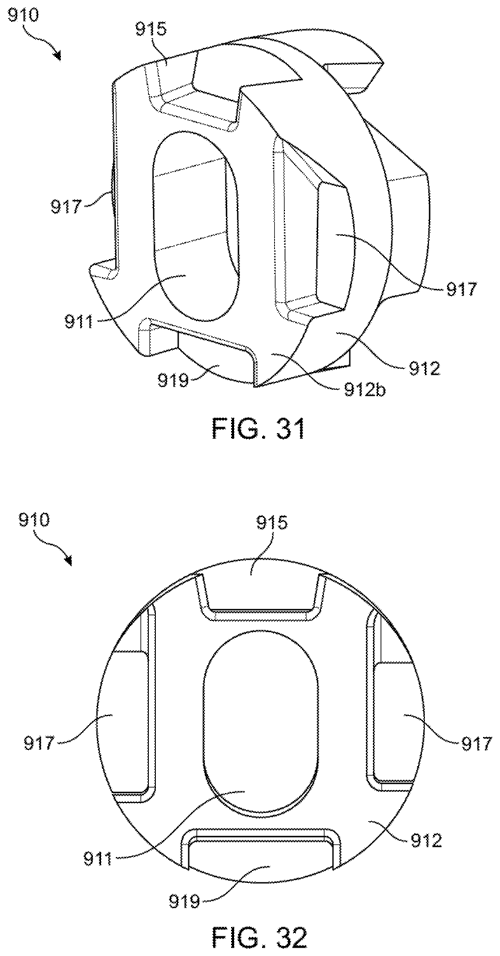

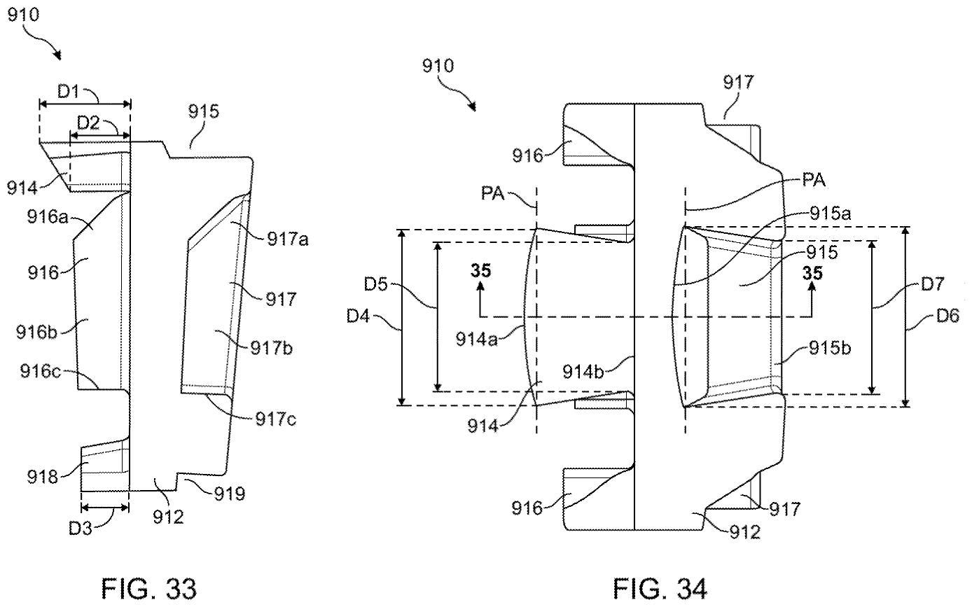

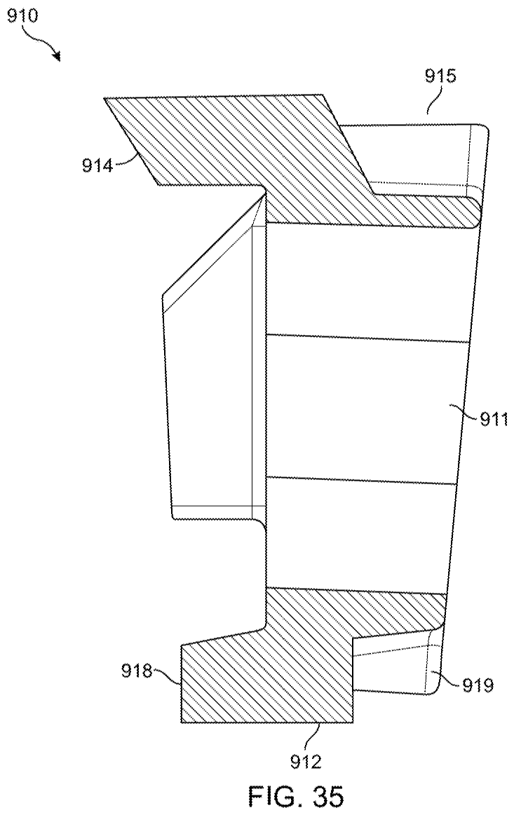

FIGS. 20-22 illustrate another embodiment of an inter-engaging disc 130 for use with a first coupling component 132 (illustrated in FIGS. 23 and 24) and a second coupling component 134 (illustrated in FIGS. 25 and 26) to form a modular corner rail assembly. Multiple discs 130 are assembled with a first coupling component 132 and second coupling component 134 as described above for inter-engaging discs 102 and its corresponding first coupling component 104 and second coupling component 106 and as illustrated in FIGS. 4-19. However, in place of two apertures for accommodating a cable and other components, the disc 130 includes a single teardrop aperture 136 with the aperture 136 tapering from the edge of the disc 130 to the center of the disc 130. The first coupling component 132 (FIGS. 23 and 24) includes a matching teardrop aperture 138, and the second coupling component 134 (FIGS. 25 and 26) also includes a matching teardrop aperture 140. The teardrop apertures (136, 138, 140) are arranged such that when multiple discs 130 are coupled together with a first coupling component 132 and second coupling component 134, the teardrop apertures (136, 138, 140) align to form a passageway. This passage is arranged to accommodate a cable 108. The cable 108 can be freely passed through the teardrop apertures (136, 138, 140) from one end of a modular corner rail assembly to the other end of the modular corner rail assembly, and ultimately from one end of a rail system to the other end of the rail system. When the cable 108 is inserted and tensioned, the cable 108 moves toward the narrow end of the teardrop apertures 136, 138, 140 (i.e., toward the center of the disc 130, first coupling component 132, and second coupling component 134) and generally to the center of the modular corner rail assembly. This movement toward the center of the modular corner rail assembly can create more space for the insertion of a power cord or other components that may be needed to span all or significant portions of the rail system.

With the arrangement of the modular corner rail assembly 100 as described herein, an installer can use fifteen discs 102 or 130, and both coupler components 104 or 132 and 106 or 134, to form a ninety degree modular corner rail assembly 100 to accommodate a ninety degree turn in a staircase. If the staircase includes a 180 degree turn, the installer can form two ninety degree modular corner rail assemblies 100 to accommodate the 180 degree turn. In such a situation, the installer can use a modular post assembly to couple the two ninety degree modular corner rail assemblies 100 together and add support to such a coupling. It will also be appreciated that the use of discs 102 or 130 facilitates the corner rail assembly 100 not only forming a general arc in two dimensions, but the assembly of discs 102 or 130 can also be arranged so that the corner rail assembly 100 forms a three dimensional curve. This is to say, that the corner rail assembly 100 can bend to accommodate a ninety degree turn in the staircase and also extend upward to accommodate the rise due to additional steps around that ninety degree turn.

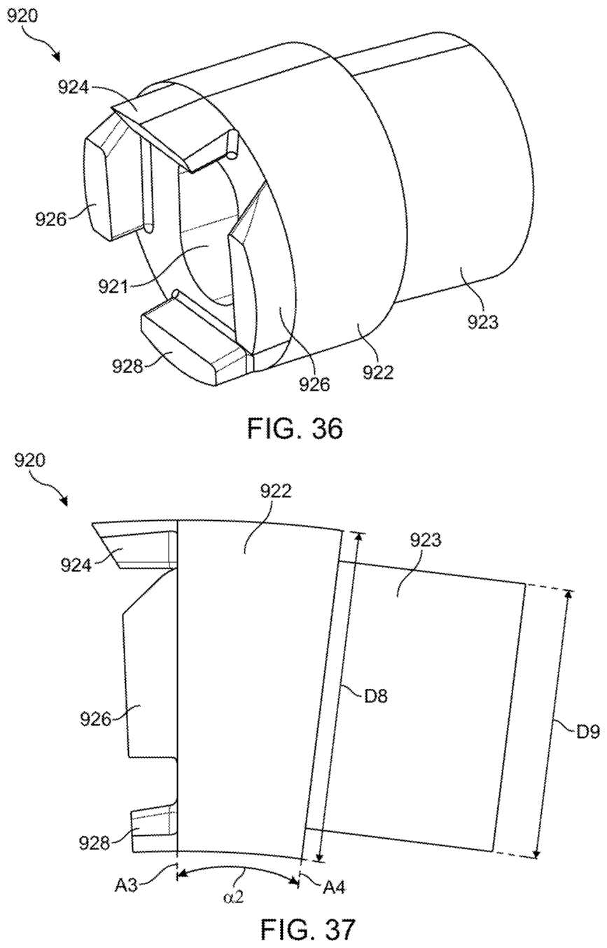

Referring generally to FIGS. 27-41, various views and configurations of rail segments are shown and described. The rail segments in FIGS. 27-41 are rail segments configured to be coupled together to form a curved section of a rail. The rail segments in FIGS. 27-41 are configured such that the segments engage and mate with each other only via a rotational motion in one rotational direction between two adjacent segments. Once the rail segments are engaged (e.g., coupled together, etc.), the rail segments are configured to resist rotation as well as tension to reduce the likelihood of the rail segments disassembling during use. In other words, any two adjacent rail segments can only be assembled to or disassembled from each other by pivoting one segment relative to the other about a single axis, such that the two segments move relative to each other about a single rotational degree of freedom. In some embodiments, the single rotational degree of freedom is not a degree of freedom that experiences loads during standard use of the rail as to reduce the likelihood of or prevent the rail segments from decoupling when undesired (e.g., during use).

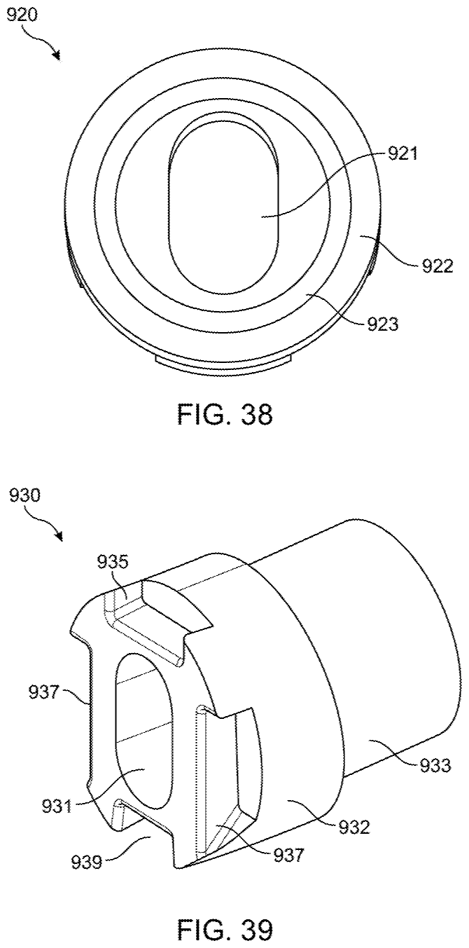

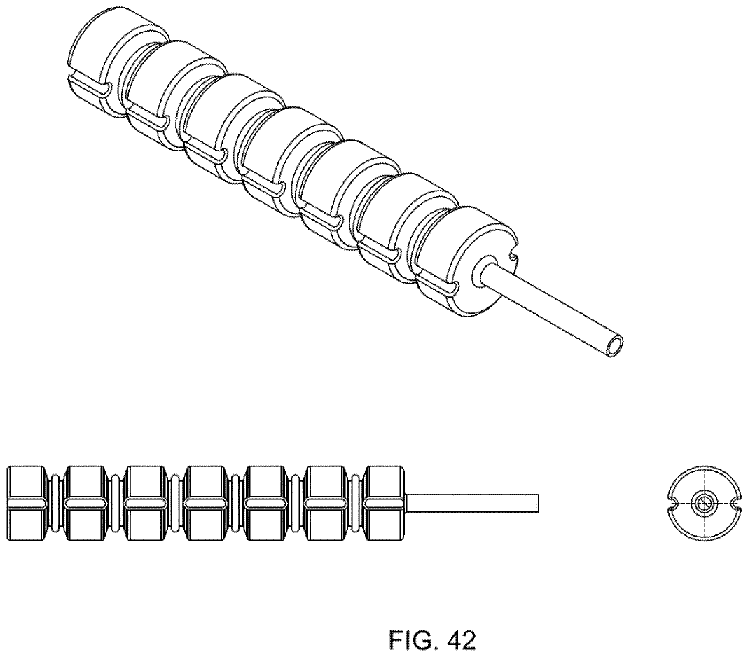

Referring generally to FIGS. 27-28, a rail system 900 is shown. The rail system 900 includes a plurality of rail segments 910. In some embodiments, the rail system 900 can be used in a modular rail assembly such as the modular rail assembly 10 of FIG. 1. The rail system 900 is configured to be disposed along portions of a rail that are curved. The multiple components (e.g., the rail segments 910) of the rail system 900 allow for the rail system 900 to be modular so that an installer can customize (e.g., the length, the curve angle, etc.) the rail system 900 for the staircase where the rail is installed. For example, the number and/or type of assembled rail segments 910 that are included in the rail system 900 can be varied to customize the length and/or a curvature and associated curve angle of the rail system 900. In some embodiments, the rail segments 910 are wedge shaped or curved modular segments that are substantially identical components, such that the same configuration of rail segment 910 can be used to form curved sections of rail having varying arc lengths and degrees of curvature or angles of curvature. In some embodiments, the rail system 900 can include a combination of different rail segments, such as rail adapter segments, as further shown and described in reference to FIGS. 36-41. The rail system 900 can be used in combination with preformed (e.g., uniform, etc.) rail segments such as straight rail segments, corner rail segments, and/or other modular components disclosed herein to form a complete modular rail assembly.

FIG. 27 illustrates a side view of rail segments 910 about to be engaged with each other via rotation of one segment with respect to the other, and FIG. 28 illustrates a side view of multiple rail segments 910 engaged with each other in series to form a curved rail system 900. As seen in FIG. 27, the rail segments 910 are identical components and are configured to engage each other (e.g., couple) via a rotation R about a single axis and a single degree of freedom. For example, during assembly of the rail system 900, a first rail segment 910a is angled relative to a second rail segment 910b, and the second rail segment 910b is pivoted about and towards the first rail segment 910a such that the rail segments 910a, 910b are rotated into engagement with each other about the rotational direction R until the rail segments 910a, 910b are coupled (e.g., locked, engaged, etc.) together. When coupled together, as further shown and described in reference to FIG. 28, the rail segments 910a, 910b are prevented from being separated from each other by linear movement with respect to each other about any of the three translational degrees of freedom (i.e. they can't be separated by moving either rail segment 910a, 910b about any of the X, Y, or Z axes away from each other), as the rail segments 910 are designed so that the rail segments can only couple/decouple via a pivoting rotation about a single rotational degree of freedom in the rotational direction R shown in FIG. 27. In some embodiments, the rotational direction R is oriented along a direction about which the rail system 900 is unlikely to receive forces during operation that would act to separate the coupled segments 910. For example, when the rail system 900 is used for a stairlift, the rotational direction R is configured to reduce the likelihood that a stairlift carriage (e.g., wheel, etc.) will separate the coupled rail segments 910. In some embodiments, the rotation R can be oriented such that the gravitational forces acting on the stairlift carriage, and a user seated thereon, act in a direction other than along the rotational direction R, thus reducing the likelihood of the rail segments 910 decoupling.

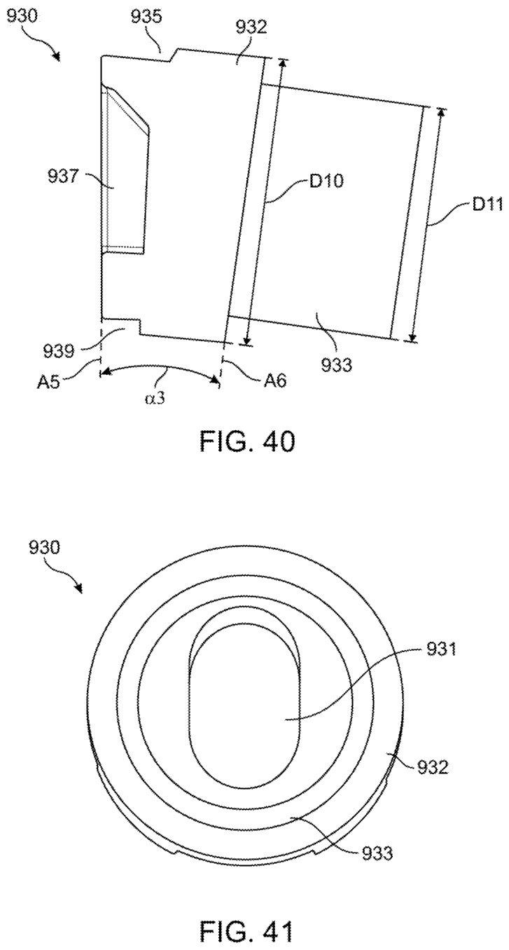

Referring to FIGS. 29-30, each of the rail segments 910 includes a body 912 and a plurality of protrusions 914, 916, 918 extending away from the body 912 in the same direction. In one embodiment, the plurality of protrusions 914, 916, 918 extend away from a first face 912a, or front face, of the body 912 of each rail segment 910. In some embodiments, the rail segments 910 can have a substantially circular cross section. In some embodiments, the cross section of the rail segments 910 is associated with (e.g., substantially similar to) a cross section of an associated rail (e.g., linear portion), such that a stairlift carriage can smoothly transition to the rail system 900 to and from other sections of the modular rail. In some embodiments, the cross section of the rail segments 910 can be oval, polygonal, and/or any other suitable shape configured to interface with carriage rollers or drive system of the stairlift. In some embodiments, the rail segments 910 can be formed of a metal such as aluminum, steel, and/or the like. In some embodiments, the rail segments 910 can be formed of a polymer such as plastic, thermoplastic, a composite, and/or the like.

Referring to FIGS. 31-32, the body 912 of each rail segment 910 defines a plurality of complementary recesses 915, 917, 919 configured to receive respective ones of the associated protrusions 914, 916, 918 from another adjacent rail segment 910 coupled thereto. In an exemplary embodiment, the plurality of recesses 915, 917, 919 are recessed into a second face 912b, or back face, on the opposing side of body 912 of each rail segment 910 that is opposite the first face 912a. The protrusions 914, 916, 918 and recesses 915, 917, 919 are arranged around associated locations on the body 912 so that the protrusions extending from the first face 912a (i.e. front face) of one rail segment 910a can engage the respective recesses defined in the second face 912b (i.e. back face) of another adjacent rail segment 910b, as shown in FIG. 28. The protrusions include a keying protrusion 914, a pair of side protrusions 916, and a center protrusion 918. The recesses include a keying recess 915, a pair of side recesses 917, and a center recess 919. In some embodiments, the rail segments 910 can include additional protrusions and/or recesses based on desired interlocking, coupling, rotational resistance, and/or the like. For example, additional protrusions and recesses can be included to be changed based on a desired load capacity, torsional rigidity, and/or the like. While the rail segments of the embodiment shown in FIGS. 29-32 each show four protrusions and four complementary recesses, in alternate embodiments each rail segment 910 can have fewer than four protrusions and four complementary recesses (e.g. two or three protrusions, and two or three recesses) or greater than four protrusions and four complementary recesses (e.g. five, six, seven, or more protrusions, and five, six, seven, or more recesses) without departing from the scope of the present disclosure. In some embodiments, each protrusion and corresponding recess can be substantially the same shape (e.g., complementary shapes) and/or protrusions and corresponding recesses can be slightly different sizes.

The keying protrusion 914 is a protrusion configured to engage the keying recess 915. The keying protrusion 914 and the keying recess 915 are shaped (e.g., angled, dovetailed, trapezoidal, tapered, etc.) to provide a specific coupling path (e.g., along the rotation R) to engage the rail segments 910. In some embodiments, the keying protrusion 914 has a substantially wedge-shaped or dovetail-shaped profile that tapers from a broader tip 914a to a narrower base 914b. Similarly, the keying recess 915, which accepts the keying protrusion 914, has a complementary shape to that of the keying protrusion 914, and defines a base surface 915a of the recess 915 that is wider or broader than an opening 915b of the recess 915. In this manner, the keying protrusion 914 and the keying recess act like a dovetail joint. The shape of the keying protrusion 914 on a first rail segment 910a, as well as the associated keying recess 915 of a second rail segment 910b, are configured to interlock to prevent the rail segments 910a, 910b from being linearly pulled apart after coupling. When the keying protrusion 914 of one rail segment 910a and the keying recess 915 of an adjacent rail segment 910b are rotatably/pivotably coupled to each other, the shapes of the respective keying protrusion 914 and the keying recess 915 reduce the likelihood of separation along linear translational directions/degrees of freedom (i.e. along the X, Y, or Z axes), and/or two of three rotational degrees of freedom, only allowing rotational movement along a single rotational degree of freedom in the rotational direction R.

The side protrusions 916 are a pair of protrusions that are both extending from the same first face 912a (i.e. front face) of the body 912 of the rail segment 910, but are spaced apart so as to be disposed at opposite edges of the first face 912a of body 912. The side protrusions 916 are configured to engage the pair of side recesses 917 defined in the second face 912b (i.e. back face) of the body 912 of an adjacent coupled rail segment 910. The side recesses 917 are associated portions of the rail segments 910 that include features (e.g., cutouts, undercuts, steps, etc.) that are configured to allow for the side protrusions 916 to be received in or by the side recesses 917 during engagement of one rail segment 910a with another rail segment 910b (e.g., by pivoting rotation along the rotational direction R). Once adjacent rail segments 910 are fully engaged with each other, as shown in FIG. 28, the side protrusions 916 and the side recesses 917 are configured to prevent rotations of the rail segments 910, except in one rotational degree of freedom about the pivotal axis about which the rails segments 910 can be engaged or disengaged from each other, thus improving torsional stiffness and axial retention between the rail segments 910.

The center protrusion 918 of a first rail segment 910a is configured to engage the center recess 919 of a second adjacently coupled rail segment 910b, in a similar manner as the side protrusions 916 of a first rail segment 910a engage the side recesses 917 of an adjacent second rail segment 910b. In some embodiments, the center protrusion 918 is a protrusion that extends away from the first face 912a of the body 912 at an opposite edge to that at which the keying protrusion 914 is located on the first face 912a. The center recess 919 is a recess configured to receive the center protrusion 918 of an adjacently coupled rail segment 910. When engaged, the center protrusion 918 and the center recess 919 prevent rotation of adjacently coupled rail segments 910, except in one rotational degree of freedom about the pivotal axis about which the rails segments 910 can be engaged or disengaged from each other, and otherwise serves as an alignment feature that further aligns adjacent rail segments 910 during coupling. When fully engaged, the center protrusion 918 and center recess 919, together with the keying protrusion 914/keying recess 915 and the side protrusions 916/side recesses 917 allow the rail segments 910 to resist linear translational separation along multiple axes, thereby sharing shear and tension loads across the coupling when the rail system 900 is in use. In combination, the keying protrusion 914, the side protrusions 916, and the center protrusion 918, together with their corresponding recesses 915, 917, and 919 of each rail segment 910, cooperate to guide, seat, and lock the joint between two adjacent rail segments 910a, 910b against the loads imparted thereon that are encountered during stairlift operation. The multi-point interlocking arrangement, as well as a rotational coupling motion (e.g., along the rotational direction R) of first and second rail segments 910a, 910b about a pivot axis PA disposed at the interface of the tip of the keying protrusion 914 and the outer edge of the base of the keying recess 915, allows for the rail segments to resist translational movement, almost all rotational movement, and/or general decoupling of the rail segments 910 during intended use. Specifically, the first and second rail segments 910a, 910b are configured to couple to one another in series in the direction of a central longitudinal axis via the pivot axis (e.g., via a pivoting rotational coupling motion) in one rotational degree of freedom. The central longitudinal axis and the pivot axis are perpendicular.

As shown in FIG. 28, multiple rail segments 910 can be coupled together to form a smooth curved rail system 900 as a portion of a modular rail. The rail system 900 can include a plurality of the rail segments 910 to achieve a desired bend angle. As shown in FIG. 28, a first rail segment 910a defines a plane A1 aligned with a first face 912a of the body 912a and a second plane A2 aligned with a second face 912 b of the body 912a (second plane A2 is also aligned with a first face of the body 912b of an adjacently coupled rail segment 910b when the first and second rail segments 910a, 910b are coupled to each other). The angle α1 is the curve angle defined by any one rail segment. Two adjacently coupled rail segments 910a and 910b would have a curve angle, or angle of curvature equal to 2α1. In some embodiments, the total curve angle of the rail system 900 is associated with the number of rail segments 910 used. For example, for each rail segment 910 added, the total curve angle can increase by the angle α1. By varying the number of rail segments 910 included in the rail system 900, an installer can achieve curves spanning a range of angles, for example from approximately 15 degrees to approximately 90 degrees, to accommodate the specific requirements of a given staircase.

In some embodiments, each additional rail segment 910 that is added into a coupled-together stack of modular rail segments 910, increases the total curve angle for the rail system 900 by an identical fixed amount α1. In some embodiments, different rail segments 910 can have different angles of curvature α1. In some embodiments, the angle of curvature α1 of each rail segment 910 can be between about 3 degrees and about 15 degrees, inclusive of all ranges and values therebetween. In some embodiments, the angle of curvature α1 is about 5 degrees. In some embodiments, such as when the rail segments 910 have varying angles of curvature α1, rail segments 910 having different angles of curvature (e.g., 3 degrees, 7.5 degrees, 10 degrees, etc.) can be assembled together to allow an installer to select the appropriate combination of the fewest possible rail segments 910 to be coupled together to assemble a finished rail having a desired total angle of curvature. In exemplary embodiments, the rail segments 910 may also have varying radii of curvature as needed in cases where the assembled finished rail needs to have a smaller radius of curvature, a larger radius of curvature, or a varied radius of curvature, dependent on physical or dimensional constraints of the location at which the finished rail is to be installed. In some embodiments, the total curve angle of the rail system 900 can include the curve angles associated with adapters, as shown and described in reference to FIGS. 36-41.

In some embodiments, the rail segments 910 are held together without any additional adhesives, fasteners, locking mechanisms, and/or the like. In some embodiments, the rail segments 910 can additionally be secured together via one or more of an adhesive (e.g., epoxy, glue, etc.), fasteners (e.g., set screw, locking pin, snap ring, etc.), and/or the like. In some embodiments, and as described herein, the rail segments can be held together via a cable, such as the cable 108 (i.e. tension cable) shown and described in reference to FIG. 4.

FIGS. 29-35 illustrate various detail views of the rail segment 910, according to an embodiment. While the rail segment 910 shown and described in reference to FIG. 29-35 depicts a particular embodiment with specific protrusions, recesses, curve angles, and/or the like, other interlocking rail segments 910 with similar and/or different features can be used to form a section (e.g., curved section) of a modular rail. For example, the rail segment 910 can include different features that still allow for the rail segments 910 to couple together by a pivoting rotational movement about a single axis in the rotational direction R.

As seen in FIGS. 29-30, the body 912 of the rail segment 910 has a substantially circular cross-section. The body 912 defines an opening 911 (e.g., aperture, through-hole, etc.) through which a cable, such as the cable 108, and/or other stairlift component can be configured to extend through. In some embodiments, the opening 911 has a substantially oval cross-section. However, in some embodiments, the opening 911 can have other shapes such as circular, polygon, teardrop, and/or any other shape that allows for desired stairlift components to extend therethrough.

As seen in FIG. 29, the keying protrusion 914, the side protrusions 916, and the center protrusion 918 (collectively referred to as “the protrusions 914, 916, 918”) extend in the same direction away from a first face 912a of the body 912. As seen in FIG. 30, the keying protrusion 914, the side protrusions 916, and the center protrusion 918 are disposed around the perimeter of the body 912 around the opening 911. Specifically, the keying protrusion 914 is at a first position (e.g., 12 o'clock position, 0 degree position, etc.) on the body 912 and the center protrusion 918 is at a second position (e.g., 6 o'clock position, 180 degree position, etc.), opposite (e.g., 180 degrees away) the first position. The side protrusions 916 are located on opposite (e.g., 180 degrees away) sides of the first face 912 a of the body 912 from each other and are located in between (e.g., 90 degrees away) the keying protrusion 914 and the center protrusion 918 at a third position (e.g., 3 o'clock position, 90 degree position, etc.) and a fourth position (e.g., 9 o'clock position, 270 degree position, etc.). However, in some embodiments, one or more of the keying protrusion 914, the side protrusions 916, and the center protrusion 918 can be in different locations on the body 912. For example, the locations of the keying protrusion 914, the side protrusions 916, and the center protrusions 918 can be based on an expected load, desired locking motion (e.g., the rotation R), and/or the like.

As seen in FIG. 31, the keying recess 915, the side recesses 917, and the center recess 919 (collectively referred to as “the recesses 915, 917, 919”) are each defined in the same second face 912b of the body 912, that is opposite the first face 912a of the body 912 from which the protrusions 914, 916, 918 extend. The locations, shapes, and sizes of the recesses 915, 917, 919 are complementary to and associated with that of the protrusions 914, 916, 918. For example, the recesses 915, 917, 919 can essentially correspond (e.g., be configured to receive) and be complementary to the protrusions 914, 916, 918 with minimal or no clearance tolerance such that there is minimal clearance and movement between rail segments 910a, 910b when coupled to each other. As seen in FIG. 32, the recesses 915, 917, 919 are disposed around the perimeter of the body 912 substantially similar to the protrusions 914, 916, 918 as shown in FIG. 30.

FIG. 33 depicts a side view of the rail segment 910. As shown, the keying protrusion 914 defines a length D1 along the outside edge of the rail segment 910 from a tip of the keying protrusion 914 to the base of the keying protrusion 914 at the body 912. The keying protrusion 914 also defines a length D2 along an inside edge of the keying protrusion 914 to the base at the body 912. The keying protrusion 914 is axially tapered such that the length D1 is greater than the length D2. The axial tapering can allow for the keying protrusion 914, when engaging the keying recess 915, to rotate into place, for example by rotation about an axis defined along the very tip, or far edge, of the keying protrusion 914 which axis is parallel to the first face 912a of the body 912.

The side protrusions 916 include an angled portion 916a and a linear portion 916b. The angled portion 916a and the linear portion 916b are contiguous. The angled portion 916a is the portion of the side protrusion 916 that is adjacent to the keying protrusion 914 and tapers from the base 912 to the linear portion 916b which is substantially rectangular. Similarly, the side recesses 917 include an angled recess 917a and a linear recess 917b that are configured to receive the angled portion 916a and the linear portion 916b, respectively. Including the angled portion 916a and the angled recess 917a allows for the side protrusion 916 to be received by the side recess 917 via a rotation, such as in the rotational direction R. In some embodiments, the length, size, and/or shape of the angled portion 916a, the linear portion 916b, the angled recess 917a, and the linear recess 917b are associated with the path of the rotational direction R. When multiple rail segments 910a, 910b, 910c, etc. are coupled together, an edge of the linear portion 916b abuts a sidewall 917c of the linear recess 917b and thus prevents rotation between rail segments 910.

The center protrusion 918 defines a length D3 which defines the distance from the body 912 that the center protrusion 918 extends. In some embodiments, the thickness of the center protrusion 918 can taper along the length D3 from a maximum at the base at the body 912 to the tip of the center protrusion 918 to allow for the center protrusion 918 to rotate into place (e.g., via the rotational direction R). As the center protrusion 918 is configured to be along the inner curve of a curved segment of a modular rail, in some embodiments, the length D3 is less than the length D1 of the keying protrusion 914.

FIG. 34 depicts a top view of the rail segment 910. As seen in FIG. 34, the keying protrusion 914 is substantially wedge-shaped (e.g., trapezoidal, dovetail-shaped, etc.). The keying protrusion 914 defines a width D4 at the tip (e.g., away from the body 912) and a width D5 at the base (e.g., at the body 912). The width D4 is greater than the width D5 allowing for the rail segments 910 to resist separation when coupled. The keying recess 915 is complementary and substantially similar to the shape of the keying protrusion 914. Specifically, the keying recess 915 defines a width D6 at deepest point of the base surface 915a (e.g., within the body 912) and a width D7 at the longitudinal opening 915b of the keying recess 915. The width D6 is greater than the width D7. In some embodiments, the width D6 is substantially similar (e.g., equal) to the width D4 and the width D7 is substantially similar (e.g., equal) to the width D5. Accordingly, the mating of keying protrusion 914 of a first rail segment 910a into a keying recess 915 of an adjacent rail segment 910b creates a tapered interference fit that prevents keying protrusion 914 from being laterally removed away from, and out of engagement with, keying recess 915 in a direction perpendicular from the mating second face 912b of rail segment 910a and the first face 912a of rail segment 910b, as seen in FIG. 28. As seen in FIG. 35, which shows a cross section of the rail segment 910 along the plane 35-35, the rail segment is shaped such that multiple rail segments 910 can be arranged and coupled together in series.

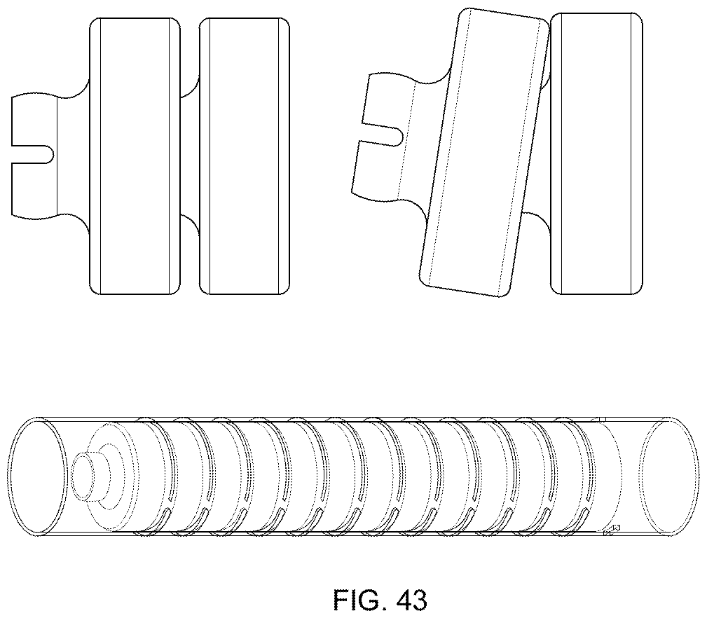

Referring generally to FIGS. 36-41, rail adapters between the rail segment 910 and another portion of the modular rail are shown. The rail adapters include a male rail segment 920 shown in FIGS. 36-38 and a female rail segment 930 shown in FIGS. 39-41 configured to couple to different portions of the rail segment 910. For example, the male rail segment 920 can be disposed at a first end of a rail system 900 and the female rail segment 930 can be disposed at a second end of the rail system 900, opposite the first end. In some embodiments, the rail adapters allow for the rail system 900 to be coupled to existing rails to reduce the number of custom-made components.

As seen in FIG. 36, the male rail segment 920 includes a body 922, protrusions, and an adapter portion 923. The male rail segment 920 is substantially similar to a portion of the rail segment 910 and is configured to engage with the recesses 915, 917, 919 of the rail segments 910. Specifically, the protrusions of the male rail segment 920 include a keying protrusion 924, a pair of side protrusions 926, and a center protrusion 928 which are respectively structurally and/or functionally similar to the keying protrusion 914, the side protrusions 916, and the center protrusion 918 of the rail segment 910. As the protrusions of the male rail segment 920 correspond to those of the rail segment 910, the male rail segment 920 is configured to engage the recesses 915, 917, 919 of the rail segment 910.

As shown in FIG. 37, which shows a side view of the male rail segment 920, the protrusions of the male rail segment 920 extend away from the body 922. The body 922 is functionally and/or structurally similar to the body 912 of the rail segment 910. The body 922 defines a third plane A3 parallel to the surface from which the protrusions extend and a fourth plane A4 parallel to the surface from which the adapter portion 923 extends. The angle between the plane A3 and the plane A4 is an angle α2 which corresponds to the curve angle of the male rail segment 920. In some embodiments, the angle α2 is between about 3 degrees and about 15 degrees. In some embodiments, the angle α2 is about 7 degrees or about 8 degrees.

The adapter portion 923 extends away from the body 922 opposite the protrusions. The adapter portion 923 is a stepped down portion that is configured to be inserted into another rail component of the modular rail. The body 922 defines a width D8 and the adapter portion 923 defines a width D9. In some embodiments, the width D8 is substantially equal to the width of the rail segment 910 and/or other rail components of the modular rail. The width D9 is less than the width D8 and, in some embodiments, is associated with an internal diameter of other rail components of the modular rail. The opening 921, as shown in FIG. 38 which shows a back view of the male rail segment 920, extends through the body 922 and the adapter portion 923. In some embodiments, the shape and/or size of the opening 921 is substantially similar to the opening 911 of the rail segment 910.

As seen in FIG. 39, the female rail segment 930 includes a body 932, recesses, and an adapter portion 933. The female rail segment 930 is substantially similar to a portion of the rail segment 910 and is configured to engage with the protrusions 914, 916, 918 of the rail segments 910. Specifically, the recesses of the female rail segment 930 include a keying recess 935, a pair of side recesses 937, and a center recess 939 which are structurally and/or functionally similar and complementary to the keying recess 915, the side recesses 917, and the center recess 919 of the rail segment 910. As the recesses of the female rail segment 930 correspond to those of the rail segment 910, the female rail segment 930 is configured to engage the protrusions 914, 916, 918 of the rail segment 910.

As shown in FIG. 40, which shows a side view of the female rail segment 930, the protrusions of the female rail segment 930 extend away from the body 932. The body 932 is functionally and/or structurally similar to the body 912 of the rail segment 910 and/or the body 922 of the male rail segment 920. The body 932 defines a fifth plane A5 extending parallel to the surface in which the recesses are defined and a sixth plane A6 parallel to the surface from which the adapter portion 933 extends. The angle between the fifth plane A5 and the sixth plane A6 is an angle α3 which corresponds to the curve angle of the female rail segment 930. In some embodiments, the angle α3 is between about 3 degrees and about 15 degrees. In some embodiments, the angle α3 is about 7 degrees or about 8 degrees. In some embodiments, the angle α2 and the angle α3 total to about 15 degrees. For example, when the angle α3 is about 7 degrees, the angle α2 is about 8 degrees, or vice-versa.

The adapter portion 933 extends away from the body 932 opposite the recesses. The adapter portion 933 is a stepped down portion that is configured to be inserted into another rail component of the modular rail. The body 932 defines a width D10 and the adapter portion 933 defines a width D11. In some embodiments, the width D10 is substantially equal to the width of the rail segment 910 and/or other rail components of the modular rail. The width D11 is less than the width D10 and, in some embodiments, is associated with an internal diameter of other rail components of the modular rail. The opening 931, as shown in FIG. 41 which shows a back view of the female rail segment 930, extends through the body 932 and the adapter portion 933. In some embodiments, the shape and/or size of the opening 931 is substantially similar to the opening 911 of the rail segment 910. In some embodiments, the male rail segment 920 can be configured to couple directly to a female rail segment 930. For example, if the desired curve in the modular rail is less than a threshold angle, only the male rail segments 920 and the female rail segment 930 can be used.

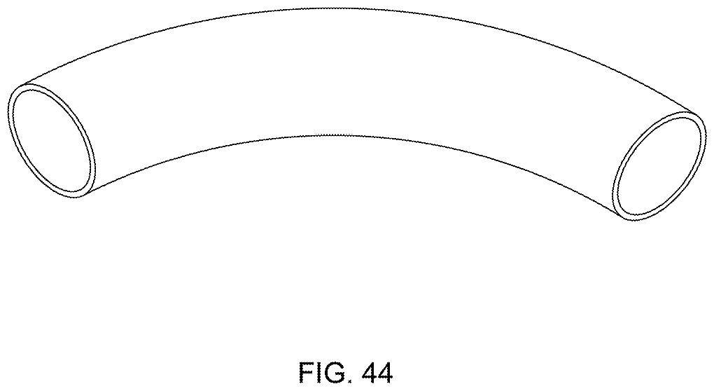

As illustrated in FIGS. 42 and 43, curved rail segments can be formed from subcomponents. In one embodiment, a set of rings that each include a ball and socket arrangement, has a ball feature on one side and a matching socket feature on the opposite side. When these rings are assembled together, the ball of one ring is engaged with a socket of another ring, and such a set of rings can each be free to rotate to mimic the bent curve of the laser cut rail segment. Such an arrangement is solid in the direction of force applied as a component of a stair lift system. In another embodiment of a curved rail segment, as illustrated in FIG. 44, the curved rail segment can be arranged as a pre-bent solid tube at various angles such as, but not limited to, 30 degrees, 60 degrees, and 90 degrees. Then, depending on the need at installation, the appropriate angled solid rail segment can be used to traverse the requirements of the staircase.

The materials and diameter and thickness of the rail segments are selected to optimize and maximize rail span of up to four feet between each modular upright post without sacrificing its strength and while maintaining the rail segment's straightness.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A rail segment for a stairlift, comprising:
a body having a first face and a second face opposite the first face, the first and second faces being disposed at a non-parallel angle to each other;
a first keying protrusion disposed on and extending from the first face;
a first keying recess defined in the second face that is in alignment with, and has a complementary shape to, the first keying protrusion, the first keying recess configured to lockingly engage with a second keying protrusion extending from an adjacent modular rail segment, which second keying protrusion has an identical shape to that of the first keying protrusion; and
an axis of rotation defined adjacent a distal end of the first keying recess and parallel to each of the first face and second face, wherein the first keying recess is configured to permit the second keying protrusion of the adjacent modular rail segment to be lockingly engaged therein via pivotably rotating the adjacent modular rail segment toward the rail segment about the axis of rotation, so as to pivotably rotate the second keying protrusion into engagement with the first keying recess to couple the adjacent modular rail segment to the rail segment.

2. The rail segment of claim 1, wherein the first keying protrusion and first keying recess prevent the rail segment from decoupling from the adjacent modular rail segment in any linear translational direction, or about any rotational axes other than the axis of rotation about which the rail segment can be pivotably rotated to couple to the adjacent modular rail segment.

3. The rail segment of claim 2, wherein, when coupled to the adjacent modular rail segment, the rail segment is prevented from lateral separation from the adjacent modular rail segment.

4. The rail segment of claim 1, wherein the body has a substantially circular cross-section.

5. The rail segment of claim 1, wherein the body defines an aperture extending therethrough between the first face and the second face.

6. The rail segment of claim 5, wherein the aperture has as an oval cross-section.

7. The rail segment of claim 1, further comprising:
a plurality of protrusions extending from the first face of the body; and
a plurality of recesses defined in the second face of the body, the plurality of recesses arranged to receive a corresponding plurality of protrusions of the adjacent modular rail segment via a rotational coupling motion.

8. The rail segment of claim 7, wherein the first keying protrusion and the first keying recess are shaped to define a coupling path along the rotation.

9. The rail segment of claim 8, wherein the first keying protrusion has a wedge-shaped profile that tapers from a distal broader tip to a proximal narrower base.

10. The rail segment of claim 9, wherein the wedge-shaped profile tapers radially and longitudinally.

11. The rail segment of claim 7, wherein the plurality of protrusions comprises a pair of side protrusions disposed on opposite edge sides of one of the first or second face of the body, and the plurality of recesses comprises a pair of side recesses disposed on opposite edge sides of the other of the first or second face of the body,
the pair of side protrusions and the pair of side recesses configured to respectively engage complementary side recesses and side protrusions of modular rail segments adjacently engaged on each of a first side and a second side of the modular rail segment, and resist rotation between the rail segment and adjacent modular rail segments when engaged.

12. The rail segment of claim 11, wherein the pair of side recesses comprises one or more angled portion configured to receive the pair of side protrusions of the adjacent modular rail segment.

13. The rail segment of claim 7, wherein the plurality of protrusions further includes a center protrusion and the plurality of recesses further includes a center recess, the center protrusion and the center recess configured to align the rail segment with the adjacent modular rail segment during coupling.

14. A rail system for a stairlift, comprising:
a first rail segment having a central longitudinal axis; and
a second rail segment, wherein the first rail segment and the second rail segment are coupled to one another in series in a direction of the central longitudinal axis via a pivoting rotational coupling motion in one rotational degree of freedom about an axis of rotation that is perpendicular to the central longitudinal axis, such that the first rail segment and the second rail segment are coupled together to form a curved section of rail.

15. The rail system of claim 14, wherein the first rail segment and the second rail segment are substantially identical segments.

16. The rail system of claim 14, wherein the first rail segment defines a first plane disposed at a proximal end of the curved section of rail and the second rail segment defines a second plane disposed at a distal end of the curved section of rail, the first plane and the second plane defining an angle of curvature therebetween for the curved section of rail of between about 3 degrees and about 15 degrees.

17. The rail system of claim 14, further comprising one or more additional rail segments coupled to the first rail segment and the second rail segment to form a curved section, wherein a total curve angle of the curved section is determined by a total number of rail segments coupled together.

18. The rail system of claim 14, wherein the first rail segment and the second rail segment are rotatably coupled to each other so as to prevent decoupling via respective movement of the first and second rail segments away from each other in any linear translational direction, or about any rotational axes other than the axis of rotation about which the first and second rail segments are rotatably coupled together.

19. The rail system of claim 14, wherein one or more engagement features of the first rail segment is configured to engage one or more engagement features of the second rail segment.

20. The rail system of claim 14, wherein the first rail segment includes a plurality of protrusions and the second rail segment includes a plurality of recesses arranged to receive the plurality of protrusions via the rotational coupling motion.
